(19) United States
(12) Patent Application Publication
(10) Pub. No.: US 2005/0053758 A1
(43) Pub. Date: Mar. 10, 2005

(54) Method, apparatus and system for creating a brush seal

(76) Inventor: Walter J. Smith, Ballston Spa, NY (US)

Correspondence Address: HESLIN ROTHENBERG FARLEY & MESITI PC, 5 COLUMBIA CIRCLE, ALBANY, NY, 12203, US

(21) Appl. No.: 10/891,424

(22) Filed: Jul. 13, 2004

Related U.S. Application Data
(63) Continuation-in-part of application No. 09/999,664, filed on Oct. 25, 2001, now abandoned.

(51) Int. Cl. D05C 15/00; B32B 33/00; A61D 1/02

(52) U.S. Cl. 428/90; 156/72

(57) ABSTRACT

A brush seal is created between two members, one of which may rotate with respect to the other. A bonding agent capable of maintaining bonding properties at temperatures below about 300° C. is applied to one or both members, each of which may include a groove for application of the bonding agent. Flexible filaments are then embedded into the bonding agent by, for example, electrostatic flocking. The flexible filaments have a ratio of free length to longest cross-sectional distance of more than about 100 and/or have a shape that includes at least one recessed surface. One example of such a shape is an n-point star.

### CROSS-REFERENCE TO RELATED APPLICATION

This application is a continuation-in-part of U.S. patent application Ser. No. 09/999,664, filed on Oct. 25, 2001, and which is hereby incorporated herein by reference in its entirety.

### BACKGROUND OF THE INVENTION

1. Technical Field

The present invention generally relates to brush seals. More particularly, the present invention relates to the creation of brush seals by embedding flexible filaments into a bonding agent.

2. Background Information

In the past, large rotating element machines, such as, for example, turbines, incorporated labyrinth seals to reduce losses between high and low pressure areas, resulting in increased efficiency for the machine. As one skilled in the art will know, labyrinth seals comprise spaced hard “teeth” projecting out from, e.g., a stationary or rotating element, and almost touching the corresponding rotating or stationary member when at rest. During start up, the teeth would often contact the corresponding member, due to thermal expansion rate differences leading to radial and axial growth disparities between stationary and rotating members, causing damage to that member and/or the teeth. Further damage is possible, due to vibration when critical speeds are reached. This damage would lead to leakage rate increases, and, hence, efficiency losses. This problem was addressed by providing additional space between the teeth and the corresponding member. However, this too reduced efficiency, since it left a larger gap between the teeth and corresponding member during operation.

Further improvements to the basic labyrinth structure included the addition of an erodible element on the member opposite the teeth. This allowed the teeth to wear away the element without physical damage to the corresponding member or the teeth during startup. Although the resulting gap was smaller than prior to the inclusion of the element, there was still an unacceptable efficiency loss. This led to the use of brushes with flexible filaments that would bend during start up. These flexible filaments produced the smallest gap yet during normal operation.

Presently, the flexible filaments are cut longer than ultimately needed, taking into account post-manufacturing trimming. In addition, the filaments are manually stacked in some fashion. Typically, the filaments are welded between two metal rings, referred to as “sealing rings.” However, up to two thirds of the space needed for the brush seal can be used by the rings. The space needed for the sealing rings is, thus, a limiting factor to the available seal width (an industry term referring to the physical width of the filaments between the traditionally present sealing rings). The process of compressing the sealing rings and the filaments together for welding and cutting the filaments to length is also labor intensive.

Thus, a need exists for a way to increase the available seal width, and, therefore, increase efficiency.

### SUMMARY OF THE INVENTION

Briefly, the present invention satisfies the need for a way to increase the available seal width in a brush seal by replacing the sealing-ring arrangement with a bonding agent and flexible filaments embedded into the bonding agent. This allows for a much larger seal width, and improved turbo machinery efficiency, at a lower cost. The pressure on each filament reduces as the overall width of the seal increases, allowing sealing at higher pressure differentials.

In accordance with the above, it is an object of the present invention to provide a brush seal with a larger seal width than currently available for a given geometry.

The present invention provides, in a first aspect, a method of creating a brush seal. The method comprises applying a bonding agent to at least one member, and electrostatically flocking a plurality of flexible filaments into the bonding agent to create the brush seal. At least one of the plurality of flexible filaments has a ratio of free length to longest cross-sectional distance of more than about 100.

The present invention provides, in a second aspect, a brush seal. The brush seal comprises at least one member, a bonding agent on a surface of the at least one member, and a plurality of flexible filaments electrostatically flocked in the bonding agent creating the brush seal. The plurality of flexible filaments comprises at least one flexible filament having a ratio of free length to longest cross-sectional distance of more than about 100.

The present invention further provides, in a third aspect, a system for creating a brush seal. The system comprises a bonding agent for applying to at least one member, a plurality of flexible filaments, and an electrostatic flocking machine for embedding the plurality of flexible filaments into the bonding agent to create the brush seal. The plurality of flexible filaments comprises at least one flexible filament having a ratio of free length to longest cross-sectional distance of more than about 100.

The present invention further provides, in a fourth aspect, a method of creating a brush seal. The method comprises applying a bonding agent to at least one member, and embedding a plurality of flexible filaments into the bonding agent to create the brush seal. The bonding agent maintains bonding properties at temperatures not more than about 300° C., and the plurality of flexible filaments comprises at least one flexible filament having a cross-sectional shape including at least one recessed surface.

The present invention further provides, in a fifth aspect, a brush seal. The brush seal comprises at least one member, a bonding agent on a surface of the at least one member, and a plurality of flexible filaments embedded in the bonding agent creating the brush seal. The bonding agent maintains bonding properties at temperatures not more than about 300° C., and the plurality of flexible filaments comprises at least one flexible filament having a cross-sectional shape including at least one recessed surface.

The present invention further provides, in a sixth aspect, a system for creating a brush seal. The system comprises a bonding agent for applying to at least one member, a plurality of flexible filaments, and a machine for embedding the plurality of flexible filaments into the bonding agent to create the brush seal. The bonding agent maintains bonding properties at temperatures not more than about 300° C., and the plurality of flexible filaments comprises at least one flexible filament having a cross-sectional shape including at least one recessed surface.

The present invention provides, in a seventh aspect, a brush seal flexible filament having a cross-sectional shape including at least one recessed surface. In one example, the cross-sectional shape comprises an n-point star as defined herein, where n is at least 3.

These, and other objects, features and advantages of this invention will become apparent from the following detailed description of the various aspects of the invention taken in conjunction with the accompanying drawings.

### BRIEF DESCRIPTION OF THE DRAWINGS

FIG. 1 depicts a bonding agent being applied within a groove of a member.

FIG. 2 depicts the member of FIG. 1 with flexible filaments electrostatically flocked into the bonding agent.

FIG. 3 depicts the member of FIG. 2 with the flexible filaments being angled.

FIGS. 4-12 depict example embodiments of brush seals in accordance with the present invention.

FIGS. 13-16 depict examples of cross-sectional shapes of brush seal flexible filaments in accordance with the present invention.

FIG. 17 is a graph of porosity versus loss coefficient for two flexible filament examples with different cross-sectional shapes.

FIGS. 18 and 19 depict cross-sectional shapes useful in explaining the phrase “longest cross-sectional distance.”

### DETAILED DESCRIPTION OF THE INVENTION

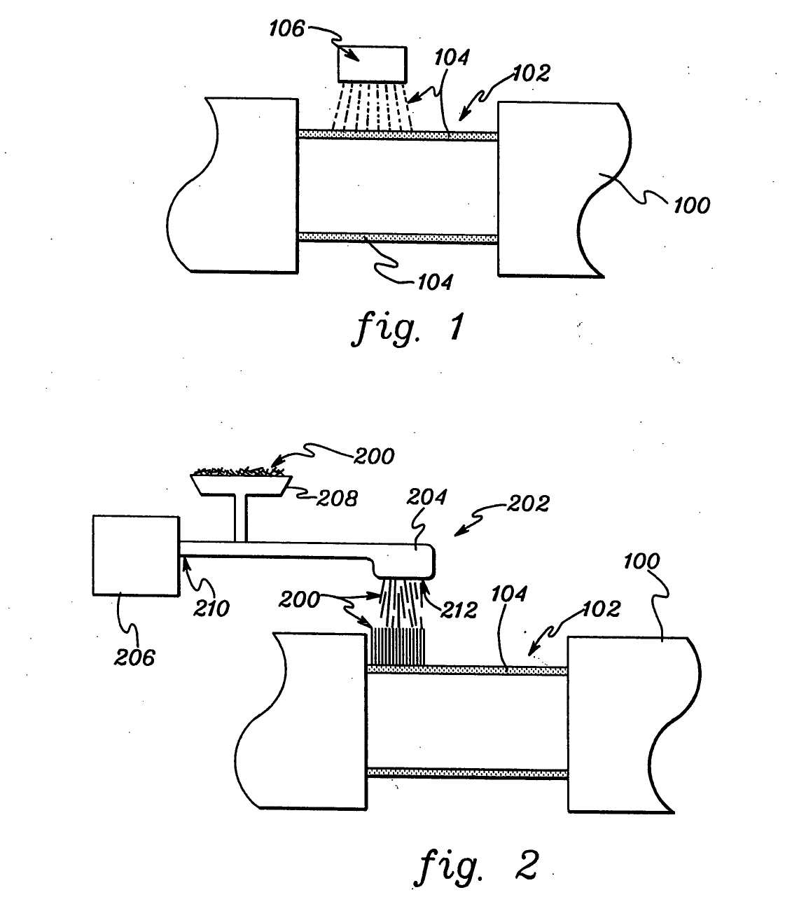

A method of creating a brush seal will now be described with reference to an example depicted in FIGS. 1-3. FIG. 1 depicts a cylindrical member 100 with a groove 102 machined therein. Cylindrical member 100 is, for example, a rotor of, for example, a turbine. Groove 102 is, for example, about 0.2 inches deep, and is machined using, for example, a lathe. A bonding agent 104 is evenly applied to the grooved area via spray applicator 106, while cylindrical member 100 is slowly rotated such that the bonding agent remains evenly distributed and does not drip off. Spray applicator 106 is, for example, an automated spray applicator, similar to that used for conformal coating of electronic components. Bonding agent 104 is, for example, a polyimide, an epoxy or a rubber adhesive. When there are one or more areas in which adherence of the bonding agent is not desired, a masking material can be applied prior to the application of the bonding agent. Examples of masking materials include tapes, or non-wetting materials, such as, for example, wax, grease, or oils including liquid silicones. This type of material is useful, for example, when an area of the groove is sought to be left without any brush seal filaments.

In the present example, bonding agent 104 is preferably evenly distributed over the surface of groove 102. However, it will be understood that the bonding agent could be unevenly distributed as well. In addition, it will be understood that the groove is not necessary for the basic invention. The bonding agent can be applied to any surface of a member. One limitation on the bonding agent is that it must maintain its adhesive strength at the maximum running temperature for the brush seal. In addition, it may be necessary in a given application to reduce capillary action between filaments. This can be done by, for example, choosing a bonding agent with a higher surface tension or by incorporating an additive to the bonding agent, or adding a thin layer of, for example, talc to the surface of the bonding agent prior to the application of the filaments. It will also be understood that spray applicator 106 could be manually controlled, or instead be a brush or other type of applicator. Further, cylindrical member 100 need not be rotated during bonding agent application; instead, the applicator could be manipulated (e.g., rotated) about the groove.

FIG. 2 depicts the cylindrical member 100 of FIG. 1 after the application of bonding agent 104 to groove 102. As shown, a plurality of flexible filaments 200 are being embedded (in this example, electrostatically flocked) into the bonding agent via flocking apparatus 202. The filaments are flexible so that during start-up of the machine, there is some “give” in the face of thermal expansion disparities, as well as running through critical speeds during startup. The flocking is done while cylindrical member 100 is slowly rotated, or, alternatively, while cylindrical member 100 remains in place and flocking apparatus 202 is manipulated about the groove. Flocking apparatus 202 comprises, for example, flocking gun 204, compressor 206, and hopper 208 to hold flexible filaments 200. The flexible filaments could be precut or cut to size after application. The compressor at one end 210 of gun 204 allows the filaments to be drawn out of hopper 208 and “shot” into bonding agent 104 at the other end 212. The flocking process can be automated or manual. In this manner, a brush seal is created with a longer seal width for a given geometry, and expressly without the need for sealing rings to stack to filaments and weld to the member. With a longer seal width, the filaments can also be smaller in cross-section, which reduces friction and improves flexibility. This can provide a more flexible seal with minimal wear of the filaments and mating seal surface.

Although compressor 206 assists in propelling filaments 200 into bonding agent 104, an electrical potential difference also does. Flocking gun 204 is kept at a positive or negative potential, AC or DC, while cylindrical member 100 is kept at a negative or positive potential (i.e., reverse polarity from the flocking gun), which causes filaments 200 exiting gun 204 at end 212 to be attracted to the cylindrical member. Further, the potential difference will also cause the filaments to align perpendicular to the surface into which they are shot, or, in this case, perpendicular to the normal of the surface where curved. The potential difference is, for example, about 50,000 volts DC.

It will be understood that although the embedding of the flexible filaments is described in this example as being accomplished by electrostatic flocking, the embedding could be done in other ways. For example, the flexible filaments could be placed, manually or mechanically (i.e., with a machine other than a flocking machine), into the bonding agent.

Some examples of materials for the flexible filaments and bonding agent at a given temperature range are given below in Table I. Note, however, that Table I is not intended to limit which combinations of flexible filament and bonding agent materials can be chosen. For example, any of the flexible filament materials listed in Table I at temperatures up to about 300° C. can be used in applications below that temperature. Likewise, higher temperature bonding agents can be used with lower temperature flexible filaments at lower temperatures. It should also be noted that in the up-to-about-300° C. category, all the example flexible filament materials listed, except for polyimides, will maintain their structural properties at temperatures above 300° C.

TABLE I

| TEMPERATURE | FLEXIBLE FILAMENTS | BONDING AGENT |
|---|---|---|
| Up to about 125° C. | natural fibers (e.g., cotton) | epoxies |
| | synthetic fibers | silicones |
| | (e.g., NYLON, | rubbers |
| | RAYON, polyester) | polyester resins |
| Up to about 150° C. | KEVLAR | |
| Up to about 200° C. | NOMEX | high temperature |
| | | silicone |
| Up to about 300° C. | polyimides (e.g., KAPTON) | polyimides (e.g., |
| | carbon fiber | KAPTON) |
| | glass | |
| | metals (e.g., copper) | |
| | cobalt-based alloys (e.g., | |
| | HAYNES 25 or | |
| | other metal alloys) | |
| | ceramic fiber | |

The flexible filaments are preferably cut to length or slightly longer to allow for some degree of wearing from friction. However, where the filaments are electrically conductive, they can begin to stick together upon exiting the flocking gun (or before) if left alone. Thus, the conducting filaments are preferably coated with an electrical insulator, such as, for example, an oxide or a nitride, so long as the melting point of the insulator is higher than that of the bonding agent. The target electrical resistance for the filaments is typically about 10⁸ to 10¹⁰ ohms for either AC or DC current.

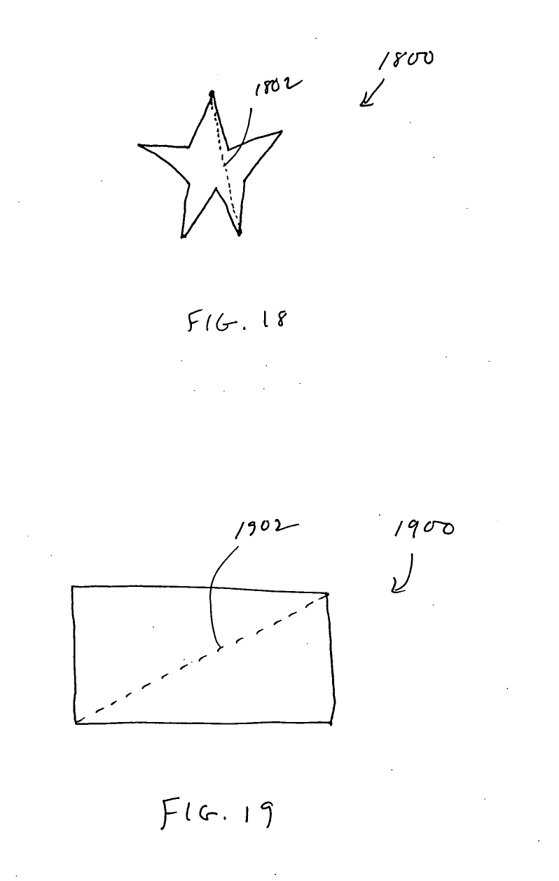

Thus, in general, whatever material is chosen for the filaments, their electrical resistance may need to be altered, by, for example, adding an insulating coating or adding a conductive coating. The coating could be applied in a number of ways. For example, the filaments could be placed in a fluidized bed of insulative or conductive material and removed, so as to fully coat them, or the insulative or conductive material could be applied to the filament stock before it is cut to length. Where the filament material is non-conductive or otherwise has a high electrical resistance, it may be necessary to add a conductor such as, for example, a conductive powder or wash, to provide the basis for electrostatic flocking. The flexible filaments can comprise any materials for which resistivity can be controlled, for example, cotton, rayon or nylon. The addition of the electrical insulator or conductor will, of course, change the stiffness and cross-sectional size of the filaments, which would need to be considered when the filaments are being designed for the particular purpose. Humidity for filaments may also need to be adjusted in order to control their electrical resistance. This is particularly true with the natural and synthetic filament materials.

Where electrostatic flocking is used to embed the flexible filaments into the bonding agent, the size of the filaments must be considered. A ratio of free length to longest cross-sectional distance for a given filament is preferably more than about 100, in order to reduce the chance that the filament will enter the bonding agent at an improper angle, resulting in possible misalignment of the surrounding filaments. The ratio is unitless, as both free length and longest cross-sectional distance have the same units. As used herein, the term “free length” refers to a length of a filament protruding out from the bonding agent. As used herein, the term “longest cross-sectional distance” of a given filament is simply the largest straight-line “width.” For a circular cross-section, for example, this would be the diameter. As another example, for a five-point star (e.g., star 1800 in FIG. 18), it would simply be the longest straight line point-to-point distance (e.g., line 1802). As still another example, for a rectangular cross-section (e.g., rectangle 1900 in FIG. 19), it would simply be the longest straight-line distance from one corner to another (e.g., line 1902).

Brush seals are not only useful in turbines. They are also useful in any application where the practical goal is to minimize loss of a gas or liquid, versus eliminating loss. Intuitively, it seems as though elimination of loss should be the goal. However, in practice it turns out that seals intended to eliminate loss frequently do so only until part of it is worn away by rotating or moving elements, for example. After that point, the loss may actually be greater than a seal in accordance with the present invention, resulting in an average loss over the lifespan of such a “complete” seal that is greater than that of the present invention. In addition, friction at startup for the present invention may be less than that for complete seals (at least until worn away), thereby reducing the torque needed to begin rotation, which can become an important factor, particularly with large machines.

One example where a brush seal of the present invention would be appropriate is the connection between a turbine and a generator. Such a brush seal would be useful where the shaft from the turbine enters the housing for a hydrogen-cooled generator, for example, in order to limit hydrogen loss. The operating temperature in such an environment would typically be less than about 100° C., and would be expected to operate up to about 40,000 before required maintenance. As another example, the present invention is useful to seal lubricating oil at a bearing on a high-speed rotating shaft. Such a mechanism would be expected to operate for up to about 10,000 hours at temperatures below about 200° C. As still another example, the present invention is useful for any rotating shaft seal to seal in liquids or gases, or to seal out solid particulate matter as well as liquids and gases. Such a mechanism would be expected to operate up to about 40,000 hours at temperatures below about 300° C. A brush seal in accordance with the present invention is practical, depending on the bonding agent and filament materials used, for operating temperatures not more than about 300° C., not more than about 200° C., not more than about 150° C., and not more than about 125° C. It should be noted that these temperatures are operating temperatures, versus temporary operation. Many bonding agents will maintain bonding properties for very short times at temperatures higher than typical operating temperatures. The temperatures herein are for ordinary operation.

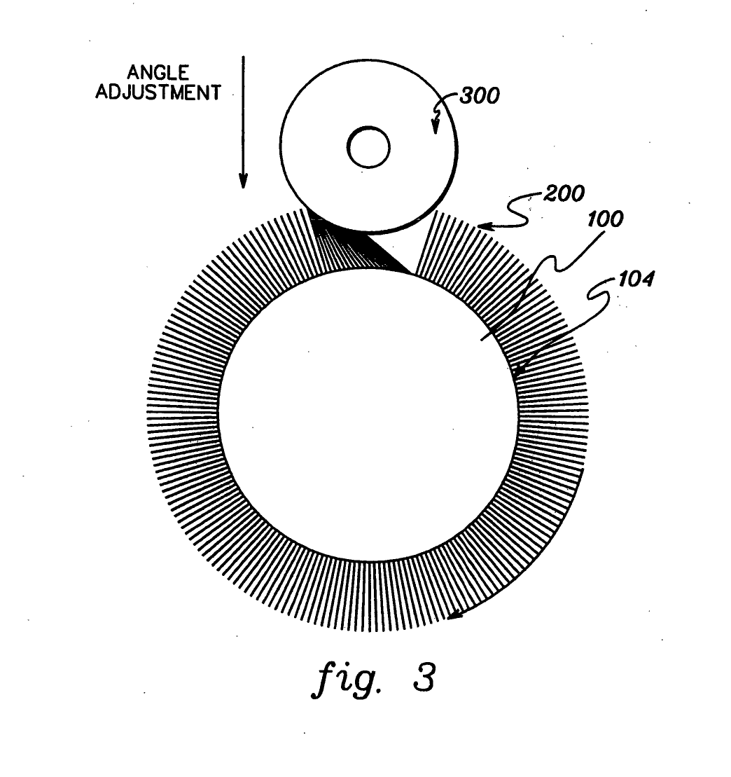

As noted above, the electrostatic flocking process results in the flexible filaments being aligned perpendicular to the surface coated with the bonding agent. For some applications, it may be desired that the flexible filaments be angled, rather than perpendicular, to the surface or normal of the member. FIG. 3 depicts a side view of cylindrical element 100 after flexible filaments 200 have been electrostatically flocked into bonding agent 104 before it hardens by cooling, chemical reaction or drying. Angle adjustment tool 300 is brought into contact with flexible filaments 200, and is simply a surface with which filaments 200 come into contact during rotation with respect to cylindrical element 100 such that the angle thereof changes to a desired angle. In the present example, angle adjustment tool 300 is simply a shaft with a smooth face that is brought into contact with the flexible filaments prior to hardening of the bonding agent. For example, although opinions differ on the issue, filament angles for turbines are currently thought to be nominally best at about 45 degrees with respect to the normal of the surface. Alternatively, angle adjustment tool 300 could have, for example, a grooved, toothed or other uneven face such that not all of the filaments become angled, some are angled to a lesser or greater extent, or the filaments are held in position in the axial direction while being tipped in the circumferential direction, which controls the axial spread of the filament tips.

In applications involving cylindrical members, for example, the members must be kept rotating until the bonding agent cures to ensure even application. Of course, it will be understood that the electrostatic flocking process can also be performed on a flat surface without rotation.

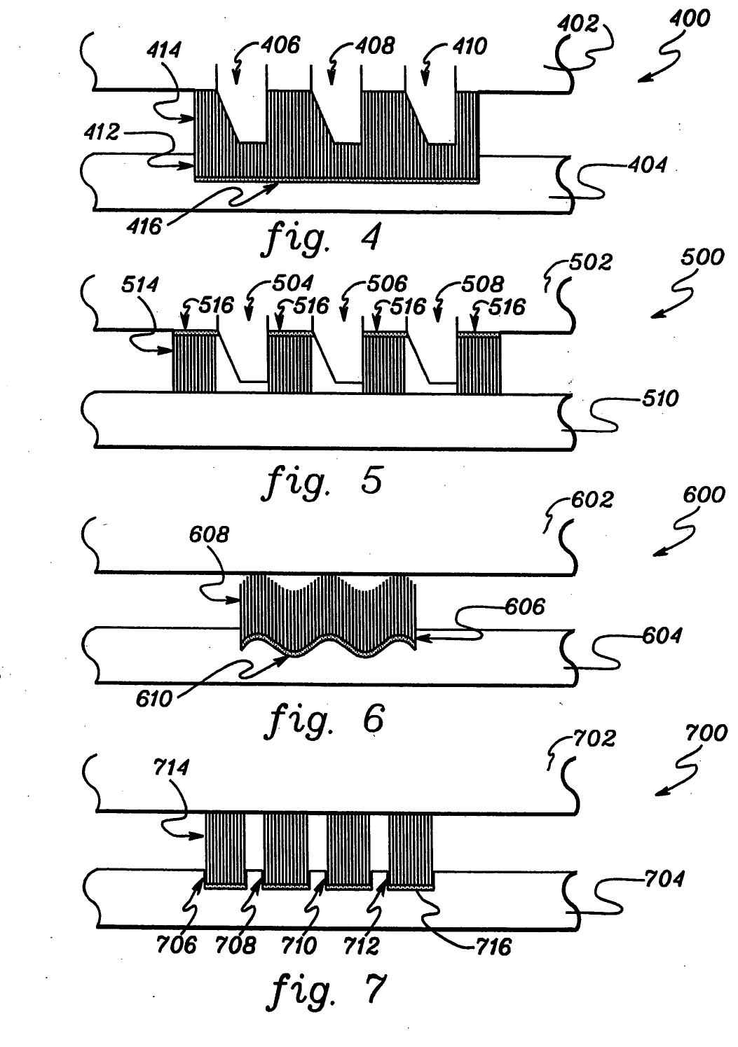

FIGS. 4 through 11 present examples of alternative embodiments for the brush seal of the present invention. FIG. 4 depicts a retrofitted labyrinth seal 400, comprising a first member 402 and a second member 404. One of members 402 and 404 rotates relative to the other. In the example of FIG. 4, labyrinth teeth 406, 408 and 410 extend out of member 402 toward member 404. The labyrinth teeth are inflexible metal. Member 404 comprises a groove 412 in which flexible filaments 414 have been electrostatically flocked into a bonding agent 416 applied thereto. However, it will be understood that groove 412 is optional. The filaments coinciding with the locations of the labyrinth teeth have been sized appropriately. However, the filaments could also be one length, allowing for trimming via friction during use. In this manner, a labyrinth seal can be retrofitted to include the brush seal of the present invention, while not removing the labyrinth teeth.

FIG. 5 depicts another embodiment of a retrofitted labyrinth brush seal 500. Like seal 400, seal 500 has a member 502 with labyrinth teeth 504, 506 and 508 extending therefrom toward another member 510. One of members 502 and 510 rotates relative to the other. Flexible filaments 514 have been electrostatically flocked into a bonding agent 516 at the surfaces between the labyrinth teeth. Thus, seal 500 is similar to seal 400, except that the flexible filaments are retrofitted onto the same member as incorporates the labyrinth teeth and there is no groove into which the filaments are electrostatically flocked. It will be understood, however, that seal 500 could include grooves for the filaments. In addition, the labyrinth teeth of seal 500 act as backers for the flexible filaments to prevent them from bending over due to a pressure drop.

FIG. 6 depicts another embodiment of a brush seal 600 in accordance with the present invention. The brush seal is made between members 602 and 604, one of which rotates with respect to the other. Member 604 comprises groove 606 having various groove depths thereacross. Flexible filaments 608 have been electrostatically flocked into a bonding agent 610 within groove 606. The varying depths of groove 606 allow flexible filaments of the same length to extend different distances between members 602 and 604. It may be desired in some applications not to have all of the flexible filaments extending the same distance toward the corresponding member, for example, to reduce friction at start up and give pressure drop advantages similar to a labyrinth configuration. An alternative to FIG. 6 that also produces the different filament distances is actually cutting the filaments to the various desired lengths after the bonding agent hardens.

FIG. 7 depicts still another embodiment of a brush seal 700 in accordance with the present invention. Brush seal 700 is made between members 702 and 704, one of which rotates with respect to the other, with member 704 including multiple independent grooves 706, 708, 710 and 712. Each groove comprises flexible filaments, such as flexible filaments 714 in groove 706, that have been electrostatically flocked into a bonding agent applied within the groove, e.g., bonding agent 716 in groove 712. The design of brush seal 700 allows for flexible filaments of all the same length with spaces in between groups of filaments. In addition, one edge of each groove will act as a backer, as explained with regard to FIG. 5. Further, it will be understood that the grooves are optional, and the bonding agent could be applied directly to the surface of member 704. A masking material can be used to eliminate bonding of filaments between groups.

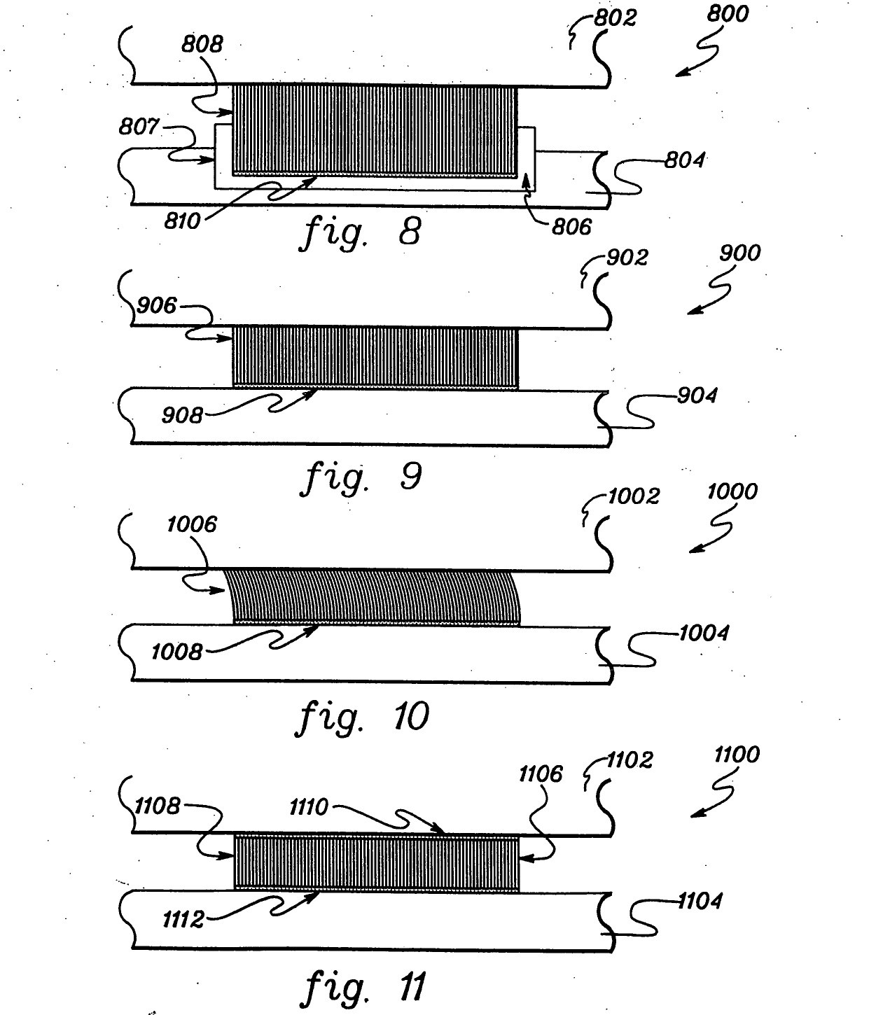

FIG. 8 depicts yet another example of a brush seal 800 between members 802 and 804, one of which rotates with respect to the other. Member 804 includes a separate member 806 (in this case, a ring) placed within a groove 807 of member 804. Member 806 includes flexible filaments 808 electrostatically flocked into a bonding agent 810. One side wall of member 806 will act as a backer for the flexible filaments. Since member 806 is separate from member 804, it allows the electrostatic flocking to be done prior to the coupling of member 806 and member 804. In some cases, however, member 806 may need to be attached to member 804 in two or more segments, for example, if it is a ring being put on the inside diameter of a turbine member. In addition, if the flexible filaments will be angled, it may also be advisable to angle the ring cut to correspond with the angle of the filaments, preventing a gap therein. In one example, member 806 is a non-metal, but member 804 is metal, and member 806 is adhered to member 804 with an epoxy or other bonding agent. In another example, member 806 has no side walls, in which case a side wall of groove 807 would act as the backer.

FIG. 9 depicts still another example of a brush seal 900 between members 902 and 904, one of which rotates with respect to the other. Member 904 includes flexible filaments 906 electrostatically flocked into a bonding agent 908 on the surface of member 904.

FIG. 10 depicts another brush seal 1000 at startup between members 1002 and 1004, one of which rotates with respect to the other. Member 1004 includes flexible filaments 1006 electrostatically flocked into a bonding agent 1008 on the surface of member 1004. As shown, filaments 1006 are longer than necessary and have a slight bend. This is due to and addresses thermal expansion that can occur in some systems (e.g., gas turbines) after the startup period, at which time members 1002 and 1004 move away from each other. In another scenario without thermal expansion, or to a lesser extent, excess length of the flexible filaments simply wears away over time leaving a zero tip clearance.

FIG. 11 depicts yet another example of a brush seal 1100 between members 1102 and 1104, which are generally stationary with respect to each other, except for some relative movement due to uneven thermal expansion and/or vibration (e.g., between two plates). Each of members 1102 and 1104 includes a plurality of flexible filaments (i.e., filaments 1106 for member 1102, and filaments 1108 for member 1104) electrostatically flocked into a bonding agent 1110 and 1112, respectively, applied thereto.

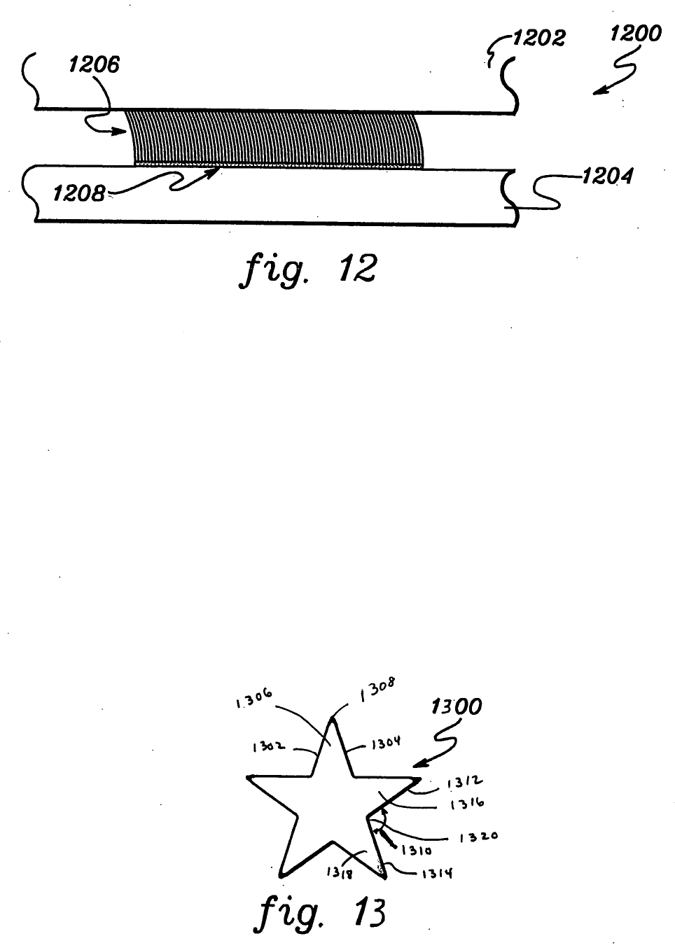

FIG. 12 depicts still another example of a brush seal 1200 between members 1202 and 1204, which are generally stationary with respect to each other, except for some relative movement due to uneven thermal expansion and/or vibration (e.g., between two plates). Member 1204 includes flexible filaments 1206 electrostatically flocked into a bonding agent 1208 on the surface of member 1204. As shown, filaments 1206 are longer than necessary and have a slight bend. This is to accommodate the relative movement from uneven thermal expansion and/or vibration.

The efficiency of a brush seal is affected by the cross-sectional shape of the individual filaments. While brush seal filaments in the past have had a circular cross-sectional shape, the present invention utilizes a cross-sectional shape with at least one recessed surface, for example, an n-point star cross-sectional shape. As used herein, the term “n-point star” shape refers to a shape that has at least three arms (i.e., n≧3), the faces of each arm extending from the body of the star and meeting either actually or extendedly in a sharp point, and where an angle between the faces of adjacent arms (either the actual angle if the faces meet at a point, or angle between the extensions of the faces if they meet at a radiused area) is less than 180 degrees from the perspective of outside the filament looking into the filament, as illustrated in the following examples.

To illustrate examples of what is meant by the “n-point star” shape, reference is first made to FIG. 13, depicting a common five-point star shape 1300. Here, there are five arms, and the faces of each arm (e.g., faces 1302 and 1304 of arm 1306) meet in an actual sharp point 1308. The angle 1310 between the faces 1312 and 1314 of arms 1316 and 1318, respectively, for example, is less than 180 degrees looking from outside shape 1300. Here, the faces 1312 and 1314 of adjacent arms 1316 and 1318 meet at a point 1320.

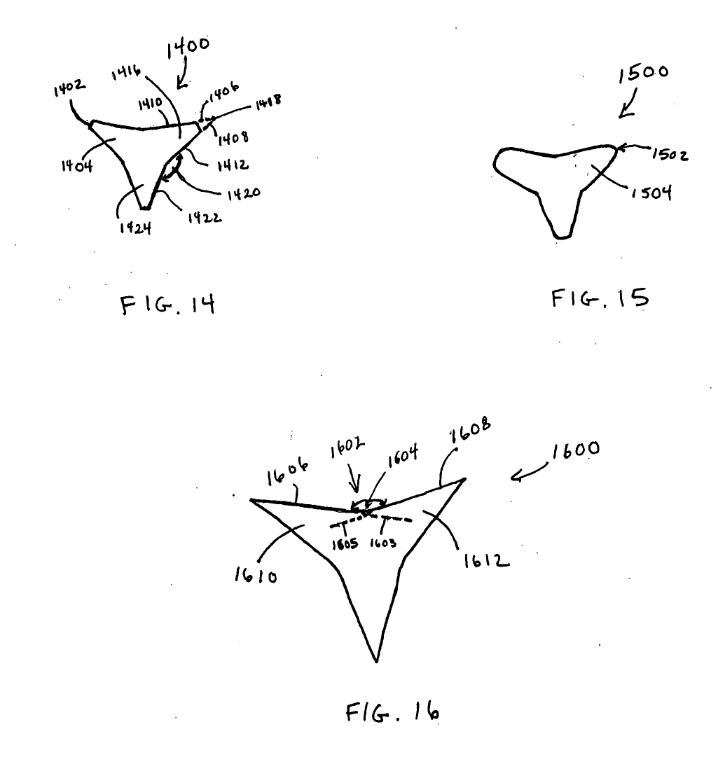

As a further example of an n-point star, reference is now made to FIG. 14, depicting a three-point star 1400. The star has three arms (the number of arms will always equal the number of points). Each of the arms has a blunted end where the faces of the arm meet, for example, blunted end 1402 of arm 1404. Extensions 1406 and 1408 of faces 1410 and 1412, respectively, of arm 1416 culminate in a sharp point 1418. Here again, the actual angle between the faces of adjacent arms is less than 180 degrees, for example, angle 1420 between face 1412 of arm 1416 and face 1422 of arm 1424.

FIG. 15, another example of an n-point star, is similar to FIG. 14, except that the star 1500 has arm ends that are outwardly radiused (e.g., end 1502 of arm 1504), rather than blunted.

Reference is now made to FIG. 16, depicting still another example of a three-point star 1600. The prior examples depicted the angles between the faces of adjacent arms meeting at an actual point. However, it is also contemplated that the faces can meet at a radiused area, e.g., radiused area 1602. The angle of interest, e.g., angle 1604, is thus an angle between the extensions 1603 and 1605 of faces 1606 and 1608, respectively, of arms 1610 and 1612, again, from the perspective of outside the shape looking into it. Here again, angle 1604 is less than 180 degrees.

Although each of the examples above depicted an n-point star with all the arms culminating in the same type of end, it will be understood that arms on the same star could have a mixture of pointed and non-pointed ends. In addition, it will be understood that other non-pointed ends could be used besides blunted and outwardly radiused.

Where electrostatic flocking is used, note that random orientation of the filaments relative to each other will occur, which may help reduce flow. However, where density is an issue and the random orientation is of concern, any loss in density as compared to a sealing ring can be compensated for by careful selection of the filament shape. In fact, the careful selection of a filament shape alone will increase efficiency even on an existing sealing ring structure. Thus, adoption of the n-point star shape for filaments should increase efficiency on such an existing structure.

Although the flow resistance coefficient for the filaments varies, depending on pack density and individual fiber size, in general the flow resistance coefficient (also referred to as “drag coefficient”) is lowest for a circular cross-sectional filament. For example, assuming a single row of filaments, each having a diameter of about 0.004-0.007 inches, and a constant pressure drop across the row, filaments in a row having a square cross-sectional shape will have as much as about a 75% lower flow rate (i.e., higher flow resistance coefficient) than a row with circular cross-sectional filaments. See, e.g., Robert D. Blevins, “Applied Fluid Dynamics Handbook,” page 314, Van Nostrand Reinhold Company, 1984. Put differently, a square cross-sectional filament shape is roughly as much as five times better than a circular shape with respect to limiting flow across the pressure drop. An n-point star cross-sectional shape should limit the flow considerably better than a square. Thus, changing the shape of the filament or choosing a filament with a particular shape alone can greatly improve efficiency.

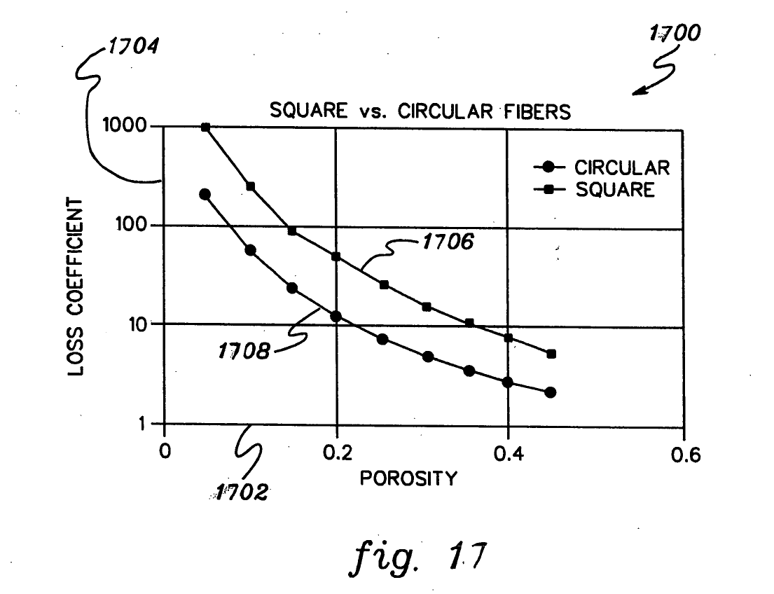

FIG. 17 is a graph 1700 of porosity on the X axis 1702 against the loss coefficient on the Y axis 1704 for the example given in the previous paragraph. The graph is derived from Robert D. Blevins, “Applied Fluid Dynamics Handbook,” page 314, Van Nostrand Reinhold Company, 1984, and is reasonably realistic for both air and steam. As shown, the line 1706 for square cross-sectional filaments has a much higher loss coefficient (i.e., flow resistance coefficient) than the line 1708 for round cross-sectional filaments at a given porosity.

In producing graph 1700 for square filaments, a turbulent flow is assumed, leading to a Reynold's number above 400. Based on Table II below, for given porosity, a loss coefficient is provided by Blevins.

TABLE II

| α | K |
|---|---|
| 0 | ∞ |
| 0.05 | 1000 |
| 0.1 | 250 |
| 0.15 | 85 |
| 0.2 | 52 |
| 0.25 | 30 |
| 0.3 | 17 |
| 0.35 | 11 |
| 0.4 | 7.7 |
| 0.45 | 5.5 |

where:
α = porosity; and
K = loss coefficient.

The loss coefficient is calculated according to the formula

$$K = \frac{β ( 1 - {a}^{2} )}{a} ,$$

where β is a function of Reynold's number (see Blevins, Table 10-17, p. 314).

For circular filaments in graph 1700, a Reynolds number above 400 (turbulent flow) was chosen to get β. For a given porosity, then, a loss coefficient can be calculated using the formula noted above. Porosity is given as, where C is the distance between filaments and D is the filament diameter. While approximate, the results for circular and square filaments are considered to be acceptable for the porosity range of interest, and show that non-circular cross-sectional shapes are indeed a significant improvement over circular. An n-point star shape as described herein will have a higher loss coefficient than that of a square, and therefore will be more effective in reducing flow through the seal. This is true for other types of seals as well, beyond those mentioned above. For example, the filament shape would be useful with seals to keep debris away from ball bearings.

Another benefit of the n-point star cross-sectional shape is improved group filament stability, both in terms of stiffness and vibration damping. The shape encourages the filaments to “lock” together, and support each other, reducing individual filament vibration and wear. This addresses the problem in brush seals of increased wear of filaments physically situated closer to the higher pressure side, as they tend to vibrate from the pressure differential and wear faster than the filaments near the lower pressure side.

While several aspects of the present invention have been described and depicted herein, alternative aspects may be effected by those skilled in the art to accomplish the same objectives. For example, to serve a similar purpose as the labyrinth teeth of FIG. 5 (i.e., as a backer for the filaments), one could add one or more backer rings to the brush seal of the present invention. Such a backer ring would not be used to couple the filaments to the member, since the bonding agent accomplishes that, but only as a support for the filaments. Although a backer would reduce somewhat the achievable seal width for a given geometry, in some applications it may be desirable to prevent over-bending of the filaments from excessive pressure drops, for example. As another example, although the brush seal embodiments herein were described as at least one of the members moving relative to the other, the movement is not necessary. At still another example, although several of the embodiments were described with or without one or more grooves into which the flexible filaments are embedded, it will be understood that the grooves are optional in each case. Accordingly, it is intended by the appended claims to cover all such alternative aspects as fall within the true spirit and scope of the invention.

1. A method of creating a brush seal, comprising:
applying a bonding agent to at least one member; and
electrostatically flocking a plurality of flexible filaments into the bonding agent to create the brush seal, wherein at least one of the plurality of flexible filaments has a ratio of free length to longest cross-sectional distance of more than about 100.

2. The method of claim 1, wherein the bonding agent maintains bonding properties at temperatures not more than about 300° C.

3. The method of claim 2, wherein the bonding agent maintains bonding properties at temperatures not more than about 200° C.

4. The method of claim 3, wherein the bonding agent maintains bonding properties at temperatures not more than about 150° C.

5. The method of claim 4, wherein the bonding agent maintains bonding properties at temperatures not more than about 125° C.

6. The method of claim 1, wherein the plurality of flexible filaments comprises at least one flexible filament having a cross-sectional shape including at least one recessed surface.

7. The method of claim 6, wherein the cross-sectional shape comprises an n-point star, and wherein n is at least 3.

8. The method of claim 7, wherein at least one arm of the n-point star is pointed.

9. The method of claim 7, wherein at least one arm of the n-point star is blunted.

10. The method of claim 7, wherein at least one arm of the n-point star is radiused.

11. The method of claim 1, wherein applying the bonding agent comprises applying an epoxy to the at least one member.

12. The method of claim 1, wherein applying the bonding agent comprises applying an adhesive to the at least one member.

13. The method of claim 1, wherein the bonding agent has a remelt point above a maximum running temperature of the brush seal.

14. A brush seal, comprising:
at least one member;
a bonding agent on a surface of the at least one member; and
a plurality of flexible filaments electrostatically flocked in the bonding agent creating the brush seal, wherein the plurality of flexible filaments comprises at least one flexible filament having a ratio of free length to longest cross-sectional distance of more than about 100.

15. The brush seal of claim 14, wherein the bonding agent comprises a material with a lower melting point than the plurality of flexible filaments.

16. The brush seal of claim 14, wherein the plurality of flexible filaments comprises at least one flexible filament having a cross-sectional shape including at least one recessed surface.

17. The brush seal of claim 16, wherein the cross-sectional shape comprises an n-point star, and wherein n is at least 3.

18. The brush seal of claim 17, wherein at least one arm of the n-point star is pointed.

19. The brush seal of claim 17, wherein at least one arm of the n-point star is blunted.

20. The brush seal of claim 17, wherein at least one arm of the n-point star is radiused.

21. The brush seal of claim 14, wherein the bonding agent has a remelt point above a maximum running temperature of the brush seal.

22. The brush seal of claim 14, wherein the bonding agent maintains bonding properties at temperatures not more than about 300° C.

23. The brush seal of claim 22, wherein the bonding agent maintains bonding properties at temperatures not more than about 200° C.

24. The brush seal of claim 23, wherein the bonding agent maintains bonding properties at temperatures not more than about 150° C.

25. The brush seal of claim 24, wherein the bonding agent maintains bonding properties at temperatures not more than about 125° C.

26. A system for creating a brush seal, comprising:
a bonding agent for applying to at least one member;
a plurality of flexible filaments, wherein the plurality of flexible filaments comprises at least one flexible filament having a ratio of free length to longest cross-sectional distance of more than about 100; and
an electrostatic flocking machine for embedding the plurality of flexible filaments into the bonding agent to create the brush seal.

27. The system of claim 26, wherein the electrostatic flocking machine comprises:
a flocking gun;
a compressor; and
a hopper for holding the plurality of flexible filaments.

28. The system of claim 27, wherein the electrostatic flocking machine further comprises a power supply for producing a potential difference between the flocking gun and the at least one member.

29. The system of claim 27, wherein the plurality of flexible filaments comprises at least one flexible filament having a cross-sectional shape including at least one recessed surface.

30. The system of claim 29, wherein the cross-sectional shape comprises an n-point star, and wherein n is at least 3.

31. The system of claim 30, wherein at least one arm of the n-point star is pointed.

32. The system of claim 30, wherein at least one arm of the n-point star is blunted.

33. The system of claim 30, wherein at least one arm of the n-point star is radiused.

34. The system of claim 26, wherein the bonding agent has a remelt point above a maximum running temperature of the brush seal.

35. The system of claim 26, wherein the bonding agent maintains bonding properties at temperatures not more than about 300° C.

36. The system of claim 35, wherein the bonding agent maintains bonding properties at temperatures not more than about 200° C.

37. The system of claim 36, wherein the bonding agent maintains bonding properties at temperatures not more than about 150° C.

38. The system of claim 37, wherein the bonding agent maintains bonding properties at temperatures not more than about 125° C.

39. A method of creating a brush seal, comprising:
applying a bonding agent to at least one member, wherein the bonding agent maintains bonding properties at temperatures not more than about 300° C.; and
embedding a plurality of flexible filaments into the bonding agent to create the brush seal;
wherein the plurality of flexible filaments comprises at least one flexible filament having a cross-sectional shape including at least one recessed surface.

40. The method of claim 39, wherein the bonding agent maintains bonding properties at temperatures not more than about 200° C.

41. The method of claim 40, wherein the bonding agent maintains bonding properties at temperatures not more than about 150° C.

42. The method of claim 41, wherein the bonding agent maintains bonding properties at temperatures not more than about 125° C.

43. The method of claim 39, wherein the plurality of flexible filaments comprises at least one flexible filament having a ratio of free length to longest cross-sectional distance of more than about 100.

44. The method of claim 39, wherein the embedding comprises electrostatically flocking.

45. The method of claim 39, wherein the cross-sectional shape comprises an n-point star, and wherein n is at least 3.

46. The method of claim 45, wherein at least one arm of the n-point star is pointed.

47. The method of claim 45, wherein at least one arm of the n-point star is blunted.

48. The method of claim 45, wherein at least one arm of the n-point star is radiused.

49. The method of claim 39, wherein the bonding agent has a remelt point above a maximum running temperature of the brush seal.

50. A brush seal, comprising:
at least one member;
a bonding agent on a surface of the at least one member, wherein the bonding agent maintains bonding properties at temperatures not more than about 300° C.; and
a plurality of flexible filaments embedded in the bonding agent creating the brush seal, wherein the plurality of flexible filaments comprises at least one flexible filament having a cross-sectional shape including at least one recessed surface.

51. The brush seal of claim 50, wherein the bonding agent comprises a material with a lower melting point than a lowest melting point of the plurality of flexible filaments.

52. The brush seal of claim 50, wherein the cross-sectional shape comprises an n-point star, and wherein n is at least 3.

53. The brush seal of claim 52, wherein at least one arm of the n-point star is pointed.

54. The brush seal of claim 52, wherein at least one arm of the n-point star is blunted.

55. The brush seal of claim 52, wherein at least one arm of the n-point star is radiused.

56. The brush seal of claim 50, wherein the bonding agent has a remelt point above a maximum running temperature of the brush seal.

57. The brush seal of claim 50, wherein the bonding agent maintains bonding properties at temperatures not more that about 200° C.

58. The brush seal of claim 57, wherein the bonding agent maintains bonding properties at temperatures not more that about 150° C.

59. The brush seal of claim 58, wherein the bonding agent maintains bonding properties at temperatures not more that about 125° C.

60. The brush seal of claim 50, wherein at least one flexible filaments of the plurality of flexible filaments has a ratio of free length to longest cross-sectional distance of more than about 100.

61. A system for creating a brush seal, comprising:
a bonding agent for applying to at least one member, wherein the bonding agent maintains bonding properties at temperatures not more than about 300° C.;
a plurality of flexible filaments, wherein the plurality of flexible filaments comprises at least one flexible filament having a cross-sectional shape including at least one recessed surface; and
a machine for embedding the plurality of flexible filaments into the bonding agent to create the brush seal.

62. The system of claim 61, wherein the machine comprises an electrostatic flocking machine.

63. The system of claim 62, wherein the electrostatic flocking machine comprises:
a flocking gun;
a compressor; and
a hopper for holding the plurality of flexible filaments.

64. The system of claim 63, wherein the electrostatic flocking machine further comprises a power supply for producing a potential difference between the flocking gun and the at least one member.

65. The system of claim 61, wherein the cross-sectional shape comprises an n-point star, and wherein n is at least 3.

66. The system of claim 65, wherein at least one arm of the n-point star is pointed.

67. The system of claim 65, wherein at least one arm of the n-point star is blunted.

68. The system of claim 65, wherein at least one arm of the n-point star is radiused.

69. The system of claim 61, wherein the bonding agent has a remelt point above a maximum running temperature of the brush seal.

70. The system of claim 61, wherein the bonding agent maintains bonding properties at temperatures not more than about 200° C.

71. The system of claim 70, wherein the bonding agent maintains bonding properties at temperatures not more than about 150° C.

72. The system of claim 71, wherein the bonding agent maintains bonding properties at temperatures not more than about 125° C.

73. A brush seal flexible filament having a cross-sectional shape including at least one recessed surface.

74. The brush seal flexible filament of claim 73, wherein the cross-sectional shape comprises an n-point star, and wherein n is at least 3.

75. The flexible filament of claim 74, wherein at least one arm of the n-point star is pointed.

76. The flexible filament of claim 74, wherein at least one arm of the n-point star is blunted.

77. he flexible filament of claim 74, wherein at least one arm of the n-point star is radiused.

78. The brush seal flexible filament of claim 73 further having a ratio of free length to longest cross-sectional distance of more than about 100.
